(19) United States
(12) Patent Application Publication
(10) Pub. No.: US 2025/0208832 A1
(43) Pub. Date: Jun. 26, 2025

(54) SYSTEM AND METHOD FOR WELL LOG NORMALIZATION

(71) Applicant: Chevron U.S.A. Inc., San Ramon, CA (US)

(72) Inventors: Donald Neal Burch, Englewood, CO (US); Sandra C. Saldana, Cypress, TX (US); Mason C. Edwards, Houston, TX (US); Arash Shushtarian, Houston, TX (US)

(21) Appl. No.: 18/850,036

(22) PCT Filed: Apr. 17, 2023
(86) PCT No.: PCT/IB2023/053919

§ 371 Date: Sep. 23, 2024

Related U.S. Application Data
(60) Provisional application No. 63/363,273, filed on Apr. 20, 2022.

(51) Int. Cl. G06F 7/499

(52) U.S. Cl. CPC G06F 7/49936

(57) ABSTRACT

A method is described for well log normalization that receives well logs including at least gamma ray logs; clustering the well logs into a plurality of well log clusters based on an interval of interest within the well logs, wherein the clustering is done based on probability density functions; for each well log cluster, normalizing each well log within the well log cluster towards a mean response of an aggregated population of the well log cluster to generate normalized well logs; and displaying the normalized well logs.

### CROSS-REFERENCE TO RELATED APPLICATIONS

This application claims the benefit of U.S. provisional patent application 63/363,273 entitled “System and Method for Well Log Normalization”, filed Apr. 20, 2022.

### TECHNICAL FIELD

The disclosed embodiments relate generally to techniques for well log normalization and, in particular, an efficient method for normalizing large numbers of gamma ray logs and/or bulk density logs.

### BACKGROUND

Use of gamma ray (GR) data from a wireline conveyed logging tool to characterize aspects of subsurface geology is quite common in the hydrocarbon and mining industries for the purpose of estimating minerology, grain size, and other inferred rock properties. These data have been routinely gathered since the 1930's in millions of wellbores around the world. The technology used in the tools themselves has evolved significantly in the last 90+ years and has seen continuous advancement by many independent companies.

While the goal of each of these individual tools is to provide an accurate representation of the background gamma ray radiation emanating from the rock immediately surrounding the wellbore in terms of radiation strength as a function of wellbore location (depth typically), there are variations in the measurements resulting from the tool mechanism itself. This is inevitable due to the statistical nature of the measurement of radiation. The result is that each individual tool has a unique calibration response that is a function of the physical components of the tool itself as well as the environmental conditions in which it is deployed e.g., temperature, distance of sensor from borehole wall, borehole fluid chemical composition, velocity of the sonde with respect to the borehole wall etc. The result is a measured gamma ray profile gathered in a particular borehole with a particular tool that represents both the geologic radioactive signature of interest superimposed with unknown signal bias introduced from the afore mentioned perturbing tool and environment induced influences.

Nearly all geologic characterization projects involve more than a single wellbore of data, ranging from several wells covering a few square miles of project area to tens of thousands of wells covering entire basins. When combining GR data from separate wellbores to compare geologic signatures, the unknown signal bias arising from individual tool signatures must be considered. This is done through a process called data normalization. The goal is to remove the tool signature (noise) without harming the underlying geologic data (signal). Since the exact tool signature is dependent on both the tool as well as the environment of deployment, adequate deterministic removal of bias is not possible without external information.

An industry standard approach of GR normalization is often referred to as a 2-point method. In this case, a target well “good” is chosen whose GR is deemed to be of high quality over the subsurface interval of interest (e.g., the portion of the wellbore through the rock formation of interest). A histogram is constructed and P10 and P90 values from the cumulative distribution function (CDF) noted. Next, the GR from a nearby “bad” well which does not exactly resemble the target well has its own histogram and CDF constructed over the same geologic interval and P10 and P90 values noted. Now, “bad” is normalized to match “good” as follows:

$$“ bad ” GR Normalized = ( “ bad ” GR + ( P {10}_{Good} - P {10}_{Bad} ) ) \times ( ( P {90}_{Good} - P {10}_{Good} ) / ( P {90}_{Bad} - P {10}_{Bad} ) )$$

The implicit and strong assumption involved with this method is that the fundamental shapes of the GR distributions between “good” and “bad” are quite similar to begin with. If this is not true, then significant distortion of the resultant normalized GR log can result along with erroneous interpretation. This type of data manipulation must be done by a trained professional with a background in both petrophysics and statistics.

Additional drawbacks to this traditional normalization method include subjective selection of “good” wells, difficulty in scaling to large datasets (i.e., being very inefficient for normalizing many well logs), and not being applicable to datasets with non-stationary geology (geology that varies between wells, even within a particular rock formation).

There exists a need for a method of well log normalization that can be applied to large numbers of well logs in a consistent way.

### SUMMARY

In accordance with some embodiments, a method of well log normalization including receiving, at a computer processor, well logs including at least gamma ray logs; clustering, via the computer processor, the well logs into a plurality of well log clusters based on an interval of interest within the well logs, wherein the clustering is done based on probability density functions; for each well log cluster, normalizing, via the computer processor, each well log within the well log cluster towards a mean response of an aggregated population of the well log cluster to generate normalized well logs; and displaying the normalized well logs is disclosed.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for well log normalization; and

FIG. 2 demonstrates a flowchart of an embodiment for well log normalization.

Like reference numerals refer to corresponding parts throughout the drawings.

### DETAILED DESCRIPTION OF EMBODIMENTS

Described below are methods, systems, and computer readable storage media that provide a manner of well log normalization. These embodiments are designed to be of particular use for normalizing large numbers (e.g. hundreds or thousands) of gamma ray logs and bulk density logs.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

An individual wellbore logged with a specific GR tool over a specific geologic interval will exhibit a unique distribution (histogram) of GR values corresponding to the unique ratio of radioactive minerals (Uranium, Potassium and Thorium) present in the interval. The shape of this unique distribution may be arbitrarily complex but nonetheless unique based on the geologic circumstance encountered in the borehole. If we now log the same well and same interval with many different physical GR tools (differences in manufacturer, vintage, speed, and borehole fluids etc.), we end up with many similar but not identical GR value distributions (differences resulting from tools, not geology).

Considering the central limit theorem, if we repeat the logging of this single well and interval with many different GR tools, the smear (“error”) in GR space of the individual logging runs becomes gaussian even for complex shaped GR distributions. Second, leveraging the law of large numbers, as the number of different tools run in the test well approaches “many”, the “true” GR distribution is represented by the mean from the aggregated distributions of all tools run.

What this implies is that if we aggregate and average all the data from the individual tools from a single well, the result is the “true” GR distribution for this geology, and thus the difference between any individual tool and the average of all tools is solely a result of tool “noise” (manufacturer, vintage, speed etc.) of that individual.

In the real world, we do not have many GR logs in the same well, rather many wells each with a single tool. To identify tool noise in this circumstance, we must identify areas where the geology is locally sufficiently stationary to assume that if multiple wells are drilled and logged in said area over the same geologic interval, that the only significant variable is the noise from tool type. In an embodiment, this is done by cluster analysis of the PDF functions of individual well GR logs over an identified interval. This yields clusters (groups) of wells where the distribution of GR values over the interval are sufficiently statistically alike to be considered the same, and thus construction of an averaged aggregate GR distribution of all members to each cluster to be the true geologic response of that cluster. Maps constructed illustrating the spatial relationships of the clusters must make geologic sense to a SME familiar with the physical processes resulting in the formation being investigated. Now each individual member distribution can be shifted towards its cluster average to effectively remove the tool noise. This is repeated for each individual in each cluster over all clusters observed in the master dataset.

More specifically, with the clustering we are attempting to isolate unique shapes of distributions of gamma ray data within a specific geologic interval to support a normalization process that is designed specifically to stabilize both the dynamic range and internal detail of the GR data such that consistent volume of clay, grain size estimation and other calculations can be made across many wells with a single set of input parameters. Furthermore, the normalized GR data should allow direct comparison of absolute GR GAPI (gamma-ray, American Petroleum Institute) value comparison well to well even when certain rock types may be absent in some boreholes.

The actual clustering is done in the probability density function (PDF) domain. Testing has shown that clustering in the PDF domain is robust but dependent on how the GR data are binned. Optimal results are obtained when the binning is neither too fine such that significant gaps of empty bins are scattered in the histogram nor too coarse such that the histogram does not provide adequate distinguishing features to differentiate it from another well. Bin widths of integer values of 1, 2 or 3 GAPI units work best, using 3 only when the overall range of observed data span 400 GAPI units or more. Since the clustering is statistical, datasets with small well counts and or short geologic intervals will challenge the method. In general terms, well counts in excess of 30 would benefit from this approach. Interval thickness and thus sample count has a direct influence on the stability of the resultant PDF. For most modern wireline data, the sample rate is 0.5 ft or similar and can give a stable PDF with as little as 100 ft of interval thickness. An embodiment may use K-Means clustering, but the principals are identical for most other clustering methods chosen as long as they are suitable for higher dimensionality datasets. Any such clustering methods are within the scope of the present invention.

The appropriate number of clusters may be user-specified. Typically, this number will range from as little as 5 to as many as 20 depending on the complexity of the geologic dynamic range being covered by the project, the number of wells, the spatial sampling and the subtlety required in the GR normalization itself. Not all normalization requirements are identical, some only require getting the data into a similar dynamic range for simple calculations while others require subtle manipulations.

As mentioned previously, the normalization process consists of moving individual wells towards the mean response of the aggregated population of the cluster of which it is a member. This “move” can be accomplished any number of ways.
It could be done using the aforementioned 2-point method, as the assumptions for the method have now been inherently met. However, data below the P₁₀ and above P₉₀ are not strictly controlled and may result in non-physical calculations
A linear scalar could be built and applied to match CDF sums. However, this method is likely not going to overlay CDF's on GR axis, resulting in DC bias
Build a polynomial remapping of the individual CDF to the master CDF. However:
   This can be fairly to highly non-linear and produce unwanted artifacts in poorly sampled portions of the individual CDF (typically at low and high GAPI values)
   Works well when data quality is very poor by forcing data into a reasonable dynamic range but with questionable absolute values

In an embodiment, an extension and augmentation of the 2-point method is used. As part of the QC process for the clustering of the PDF functions, we examine several goodness-of-fit indicators for each individual well as it pertains to its membership to a cluster. One of these indicators is an R² regression fit between the mean PDF of the aggregated data from all members of a particular cluster and the PDF of an individual member well for that cluster. We can leverage this information such that when we have high confidence in an individual well (high R²), the normalization can be more rigorous to extract as much nuanced detail as possible from the normalization and conversely when we have low confidence in a well we apply a very soft normalization to avoid creating misleading results.

The 2-point method (P₁₀, P₉₀) is extended to:
R² fit 1.0<=0.9 9-points used (P₁₀, P₂₀, P₃₀, P₄₀, P₅₀, P₆₀, P₇₀, P₈₀, P₉₀)
R² fit 0.9<=0.8 7-points used (P₁₀, P₂₃, P₃₆, P₅₀, P₆₃, P₇₆, P₉₀)
R² fit 0.8<=0.6 3-points used (P₁₀, P₅₀, P₉₀)
R² fit 0.6<=0.2 2-points used (P₁₀, P₉₀)
R² fit 0.2<not normalized

In all cases, the individual wells are bulk shifted in GR space to align their P₁₀ values with the P₁₀ mean cluster aggregate prior to subsequent Pₓₓ mapping.

To facilitate full audit capability of the processing, the final output for the normalized Gamma Ray log includes the original input log mnemonic, depth interval over which the cluster analysis and normalization was performed, any clipping that may have been done prior to clustering, cluster class membership indication, all cluster membership QC fit quality indicators, normalization method including applied P_{XX} values, date processed, business unit, code base and version.

One of the principal uses of the Gamma Ray data in the field of petrophysics is in the determination of mineralogy, or at least its disambiguation. A key additional data type in this analysis is bulk density. These two data types are frequently combined. While the GR data are nearly always normalized when dealing with multi-well datasets, the bulk density data are less so. However, projects that involve wireline data reaching back into the 1990's and prior frequently require the density data have some level of normalization applied to them. Because the density data are quite sensitive to mineralogy, it follows that we may be able to leverage aspects of our GR workflow to assist with the density data.

The clusters of GR distributions are nothing but unique mineralogic signatures of the geologic interval being investigated. We should thus expect that the bulk density data should have a very strong mimic signature in the histogram space for the same interval, and indeed that is what we observe. So, the well membership that we have built for the GR data holds perfectly for the bulk density data too.

Normalization of density data is done with a much lighter touch than for GR data, typically a simple bulk shift to match individual member bulk density P50 values to cluster mean aggregate P50 values not to exceed 0.05 g/cc or some equally small amount. However, with the robust statistics and high-quality PDF shape matching, we have confidence in recommending and justifying those shifts.

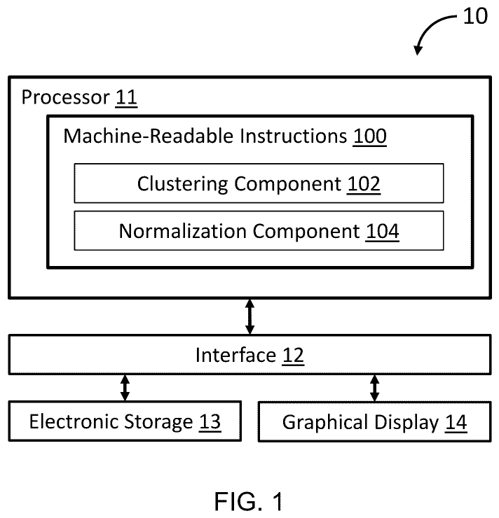

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, a graphical display 12, and/or other components.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to well logs, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to well logs, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate well log normalization. The machine-readable instructions 100 may include one or more computer program components. The machine-readable instructions 100 may include a clustering component 102, a normalization component 104, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the clustering component 102 may be configured to perform the clustering as disclosed earlier, in order to generate clusters of well logs.

The normalization component 104 may be configured to perform the normalization as disclosed earlier, wherein within each cluster each well log is normalized towards a mean response of an aggregated population of the well log cluster.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

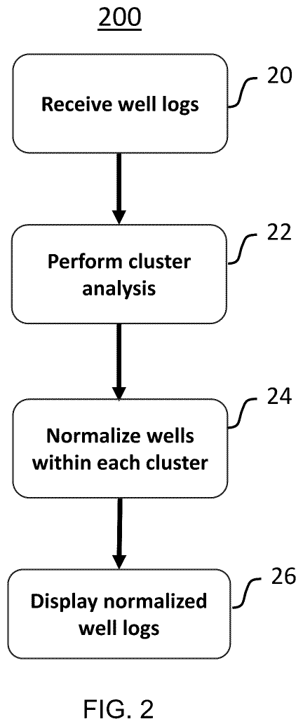

FIG. 2 illustrates an example process 200 for well log normalization. At step 20, a plurality of well logs are received; in an embodiment, the plurality of well logs would include at least thirty well logs. These well logs may include gamma ray logs and/or bulk density logs. The well logs should include data representative of subsurface rock formations of interest that are laterally extensive.

At step 22, the process 200 performs cluster analysis as described earlier.

At step 24, the process 200 normalizes the well logs within each cluster against each other, towards a mean response of the aggregated population of the well log cluster, as described earlier.

Optional step 26 displays at least the normalized well logs. It may also display original input log mnemonic, depth interval over which the cluster analysis and normalization was performed, any clipping that may have been done prior to clustering, cluster class membership indication, all cluster membership QC fit quality indicators, normalization method including applied P_{XX} values, date processed, business unit, code base and version.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of well log normalization, comprising:
a. receiving, at a computer processor, well logs including at least gamma ray logs;
b. clustering, via the computer processor, the well logs into a plurality of well log clusters based on an interval of interest within the well logs, wherein the clustering is done based on probability density functions;
c. for each well log cluster, normalizing, via the computer processor, each well log within the well log cluster towards a mean response of an aggregated population of the well log cluster to generate normalized well logs; and
d. displaying the normalized well logs on a graphical display.

2. The method of claim 1 wherein at least thirty well logs are received.

3. The method of claim 1 wherein the well logs also include bulk density logs.

4. The method of claim 1 wherein the clustering is K-means clustering.

5. The method of claim 1 wherein the normalizing is one of a 2-point method, a linear scalar, or a polynomial remapping.

6. The method of claim 1 wherein the normalizing is a 2-point method that includes an R² regression fit and performs a bulk shift.

7. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, well logs including at least gamma ray logs;
b. cluster, via the one or more processors, the well logs into a plurality of well log clusters based on an interval of interest within the well logs, wherein the clustering is done based on probability density functions;
c. for each well log cluster, normalize, via the one or more processors, each well log within the well log cluster towards a mean response of an aggregated population of the well log cluster to generate normalized well logs; and
d. display the normalized well logs on a graphical display.

8. A non-transitory computer readable storage medium storing one or more programs, the one or more programs comprising instructions, which when executed by an electronic device with one or more processors and memory, cause the device to:
a. receive, at the one or more processors, well logs including at least gamma ray logs;
b. cluster, via the one or more processors, the well logs into a plurality of well log clusters based on an interval of interest within the well logs, wherein the clustering is done based on probability density functions;
c. for each well log cluster, normalize, via the one or more processors, each well log within the well log cluster towards a mean response of an aggregated population of the well log cluster to generate normalized well logs; and
d. display the normalized well logs on a graphical display.
